(19) United States
(12) Patent Application Publication
(10) Pub. No.: US 2010/0088018 A1
(43) Pub. Date: Apr. 8, 2010

(54) Glance ahead navigation

(76) Inventors: Kevin Tsurutome, San Francisco, CA (US); Darrell Sano, Oakland, CA (US)

Correspondence Address: MANELLI DENISON & SELTER PLLC, 7th Floor, 2000 M Street, N.W., Washington, DC, 20036-3307, US

(21) Appl. No.: 12/588,141

(22) Filed: Oct. 6, 2009

Related U.S. Application Data
(60) Provisional application No. 61/136,849, filed on Oct. 8, 2008.

(51) Int. Cl. G01C 21/36; G06F 3/048

(52) U.S. Cl. 701/201; 715/810; 715/764

(57) ABSTRACT

A navigation system that allows a user to easily glance ahead down a route to see points-of-interest (POI) such as businesses along future portions of a route. POIs within a short distance radius of a selected future exit or other future point along the user's route may be presented to the user via an appropriate display. The short distance radius may be defined by constraints associated with the display (e.g., within a represented distance from the exit that can be shown in a current zoom level of the display). Instead of abandoning a navigation session, use of glance ahead instead suspends navigation while the user views snapshots of points-of-interest at each exit. The navigation system may show branded icons or business details associated with displayed POIs, preferably without the need for the user to access a separate screen.

This application claims priority from U.S. Provisional Application No. 61/136,849, entitled “GLANCE AHEAD NAVIGATION” to Tsurutome, filed Oct. 8, 2008.

### BACKGROUND OF THE INVENTION

1. Field of the Invention

This invention relates generally to navigation devices.

2. Background of the Related Art

Currently it is difficult to determine businesses located around exits during freeway travel. Seeking specific services requires leaving the route, traversing an exit, and driving around visually looking for desired businesses. This action may be repeated on subsequent exits, wasting a tremendous amount of time, effort, and vehicle fuel.

This approach also can be applied to non-freeway routes by providing point-of-interest (POI) information around business districts along a route.

In existing points-of-interest map displays, conventional applications show POI's on a map in a vicinity of navigation while the user navigates. Conventional products allow a user to view points-of-interest around a current location.

Current navigation systems fail to efficiently solve the problem of quickly and easily finding businesses at upcoming freeway exits or business districts. Drivers are unable to plan stops and make decisions during travel. Navigation session must be abandoned to perform a POI search.

### SUMMARY OF THE INVENTION

In accordance with the invention, a method of providing glance ahead points of interest (POI) information along a future segment of a currently calculated route, comprising detecting initiation of glance ahead navigation. User criteria for future POI selection is received. A plurality of future POIs meeting the criteria for future POIs is selected, the future POIs being selected during navigation of a calculated route, and the future POIs being proximate a segment of the calculated route significantly beyond a current segment of calculated route.

The current navigation was suspended, and the plurality of future POIs are presented to a navigation device presenting the calculated route. The navigation system returns to navigation of the currently calculated route.

### BRIEF DESCRIPTION OF THE DRAWINGS

Features and advantages of the present invention will become apparent to those skilled in the art from the following description with reference to the drawings:

FIG. 1 shows exemplary steps in providing glance ahead future POIs provided by a navigation system, in accordance with the principles of the present invention.

FIGS. 2A to 2H show exemplary stages of a glance ahead navigation system, in accordance with the principles of the present invention.

### DETAILED DESCRIPTION OF ILLUSTRATIVE EMBODIMENTS

The present inventors have realized that current navigation technology is unable to distinguish businesses or other points-of-interest (POI) around future freeway exits along a calculated route customized for a given user. In these conventional navigation systems, searching for POIs (Points of Interest) is based only on a radius equation of a point input by the driver via a given search criteria.

The present invention provides a navigation system that allows a user to easily glance ahead down an already calculated route to see points-of-interest such as businesses along future portions of a route. Points-of-interest (POIs) within a short distance radius of a selected future exit or other future point along the user's route may be presented to the user via an appropriate display. The short distance radius may be defined by constraints associated with the display (e.g., within a represented distance from the exit that can be shown in a current zoom level of the display).

Ideally the future POIs are presented to the user in a ranking relating to a distance from a closest point on an already-calculated route.

Importantly, a current navigation session is not abandoned, but rather use of glance ahead instead suspends navigation while the user views snapshots of points-of-interest at future segments along a calculated route, e.g., at each future exit. This is a useful feature which aids in determination of what exit to take based on available or desired business users wish to stop at.

Preferably, the navigation system in accordance with the present invention shows branded icons or business details associated with displayed glance ahead, future points-of-interest, preferably without the need for the user to access a separate screen. The invention allows for simple user interface access to move ahead to future portions of a user's current route yet to be traveled and even not yet displayed. The user may move ahead in geospatial defined distances such as exits or points-of-interest clusters or business districts.

The present invention provides glance ahead navigation capabilities that quickly and easily display points of interest, e.g., businesses, ahead of the user, e.g., around the next freeway exit. In accordance with the principles of the present invention, drivers may click ahead to future exits to view businesses, and set a reminder for later if a desired business is found. Preferably, in disclosed embodiments, navigation continues in the background.

Glance Ahead capability is preferably included in an application menu in a navigation device, e.g., mounted in a vehicle or run on a mobile phone, and for uses particularly in cases of long freeway travel. Selecting Glance Ahead performs a points-of-interest (POI) search within a given radius (preferably configurable by the user) around future freeway exits or other street intersections. In disclosed embodiments the navigation device permits the user to select not only the type of business to search for proximate to a currently calculated route, but also to select the type of upcoming road segments to search around, e.g., freeway exits, stoplight intersections, any crossroad, etc.

Each business is represented by a glance ahead future POI icon. Details and directions to the POI may be provided, either as part of the initial information provided by the navigation system, or upon subsequent request.

In disclosed embodiments, a selection of a Next Exit jump is provided by the navigation system as search criteria to the next freeway exit, and another search is performed. The user may continue to view businesses (or other glance ahead future POIs) around future freeway exits, and once a business is found, select a Reminder flag for audible cues that the desired business (or other POI) is located off the next exit.

Identification of relevant glance ahead future POI's may be performed by searching around the exit dynamically or by pre-indexing the data.

Glance ahead functions as an aid when traveling on long stretches of highways. On normal streets or boulevards, a driver clearly sees what is ahead, and makes the appropriate maneuver to stop. However, on long stretches of highways, especially unfamiliar ones, services, businesses, and other POIs may be hidden out of view or off secondary roads around the exit. Breaking travel to visually see what services exist at an exit is time consuming and impacts total travel time. Using glance ahead navigation in accordance with the principles of the present invention, a navigation application provides a snapshot prior to reaching the relevant future point on the route (e.g., an exit), and the user decides based on available services if a stop is desired.

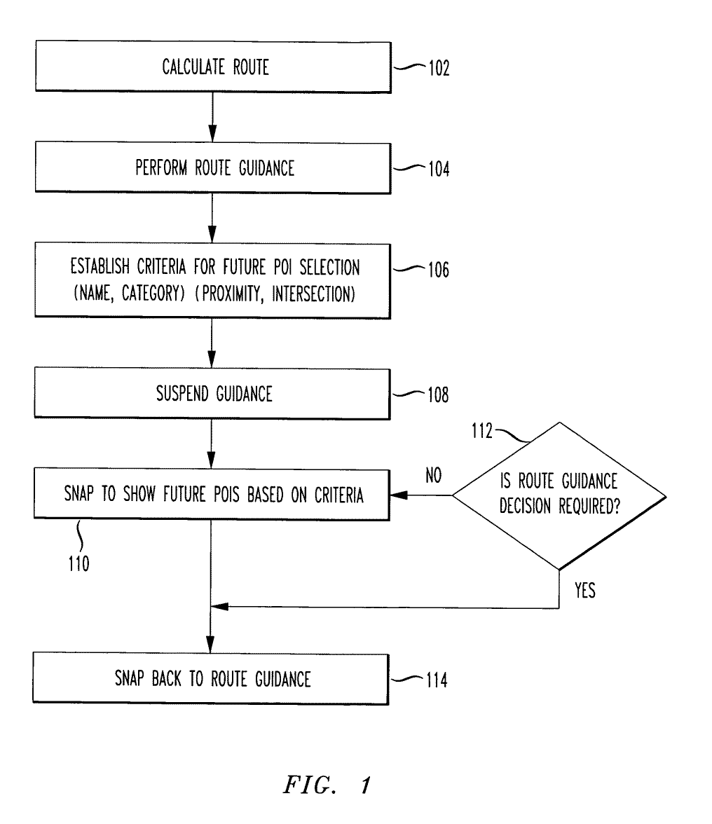

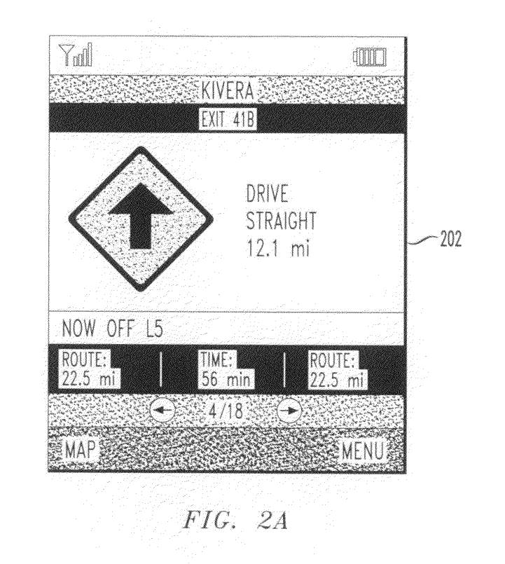

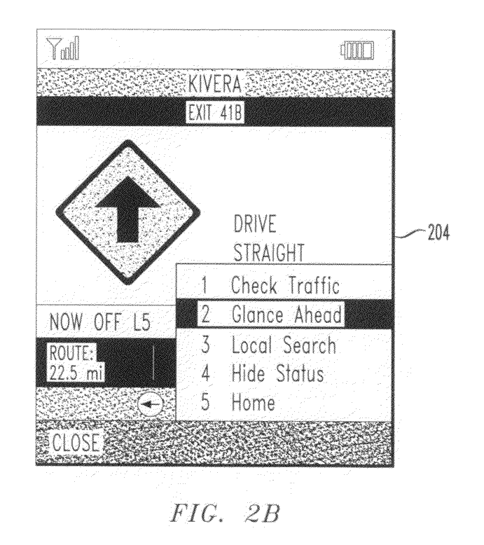

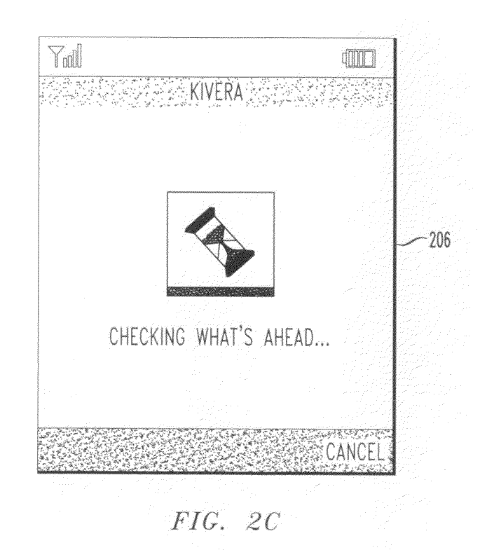

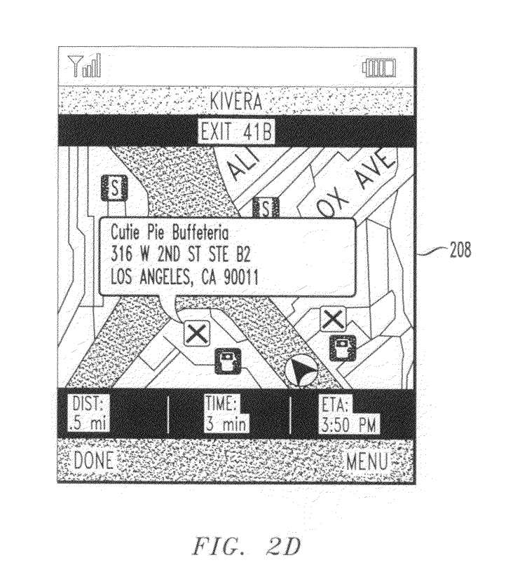

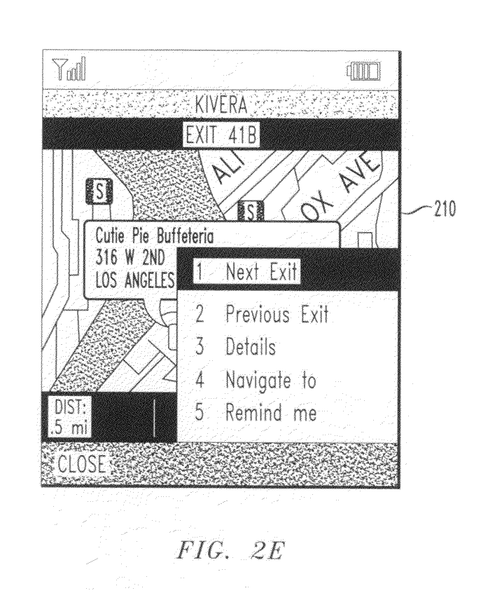

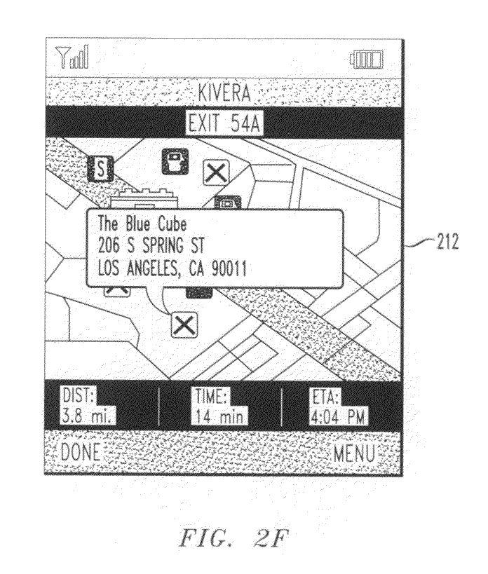

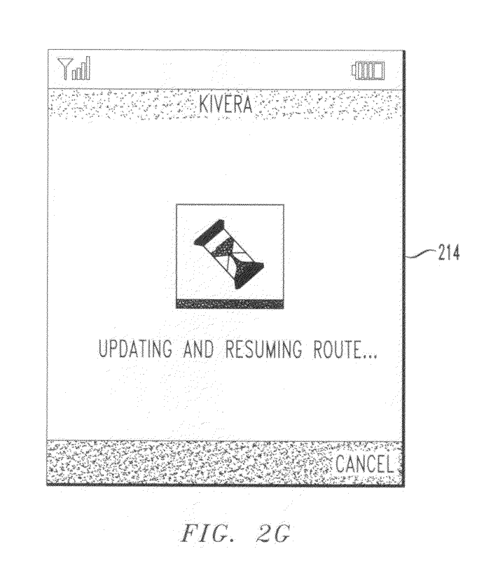

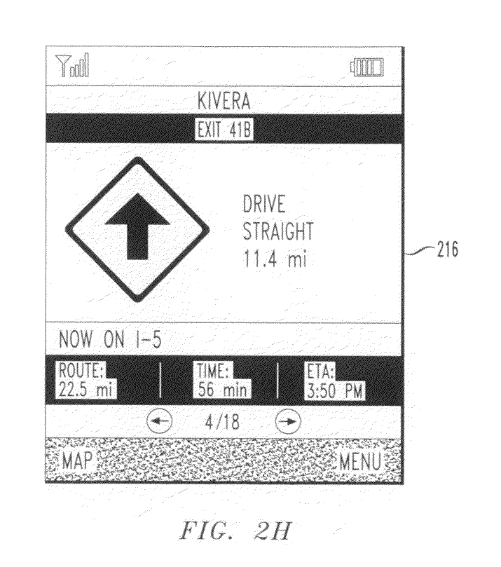

FIG. 1 shows exemplary steps in providing glance ahead future POIs provided by a navigation system, in accordance with the principles of the present invention.

In particular, as shown in step 102 of FIG. 1, a route is calculated and provided by a navigation system in an otherwise conventional manner. The navigation system may be mounted in a vehicle or operated on a mobile phone.

In step 104, route guidance is performed by the navigation system in an otherwise conventional manner. For instance, turns are displayed are audibly presented by the navigation system.

In step 106, at some point during presentation of a currently calculated route, the navigation system provides a user interface to permit a user to establish criteria for future point of interest (POI) selection. For instance, future POI selection may be selected by criteria such as business name, or category or type of business. In other embodiments, criteria may also include configuration (or adjustment from a default distance) of distance from future road segments along the currently calculated route.

The distance of the glance ahead future POIs are preferably measured in distance of travel from the currently calculated route, but may be calculated “as the bird flies” for simplicity and speed.

In step 108, at some point during initiation of the glance ahead feature (preferably once all criteria are input and after selection of glance ahead future POIs has been performed by the navigation system), the currently calculated navigation is suspended temporarily.

In step 110, the navigation system snaps away from the currently calculated navigation to display found glance ahead future POIs based on the input criteria.

The user may request a particular order of presentation of the found glance ahead future POIs if not otherwise designated. A default presentation order of glance ahead future POIs may be provided, e.g., first by those surrounding the next exit, then by those surrounding the exit following that, etc. In another embodiment, the user may designate a future exit or point along the currently calculated route beyond which to provide glance ahead future POIs.

In step 112, the currently calculated route continues in the background, and if a turn or other travel decision is required to be presented to the driver along the currently calculated route, the glance ahead is abandoned so that the navigation guidance will be presented by the navigation system.

In step 114, after the glance ahead navigation is completed, the navigation system returns to the previously suspended navigation of the currently still-calculated route.

FIGS. 1A to 1H show exemplary stages of a glance ahead navigation system, in accordance with the principles of the present invention.

In particular, FIGS. 1A to 1H show an advanced navigation search concept that glances ahead to future exits off a highway or other navigation route, and presents points-of-interest (POIs) within a short distance radius of the future exit. Instead of abandoning a given navigation system (as in conventional navigational systems), selection of glance ahead navigation temporarily suspends navigation while the user views snapshots of points-of-interest (POI) at each selected future exit.

FIG. 1A depicts a given page of otherwise ordinary navigation.

FIG. 1B shows a user's selection of glance ahead navigation. Glance ahead may be selected from a menu from, e.g., turn, map or list views.

FIG. 1C depicts the glance ahead navigation system determining the next exit (or other future point in the calculated navigation selected by the user). The navigation system performs a point-of-interest (POI) search in pre-defined categories that are common and satisfy the high percentage use cases. The POI categories to be seen may include, e.g.:
Bar or Pub
Coffee Shop
Convenience Store
Grocery Store
Restaurant
Hotel
Gas Stations
ATM

In FIG. 1D, the navigation session is suspended. If a maneuver is about to happen, it has precedence over glance ahead navigation functionality and the navigation system preferably snaps back to navigation view.

In FIG. 1E, the glance ahead menu allows users to skip to see what is around a future point, e.g., the next exit. As shown, a status panel updates with distance, time, and estimated time of arrival (ETA) to this exit. The glance ahead menu allows users to also drill down to points-of-interest (POI) details. Navigate to the POI, or set a reminder which will alert the user that they are near the POI within a defined distance.

In FIG. 1F, the user may glance ahead to as many exits as there are on their route, and therefore decide where to stop for specific services and businesses. Branded POIs may also be inserted on the displayed navigation map.

In FIG. 1G, once finished, a user may select a “done” soft key menu and the application recalculates the route and resumes navigation to the original destination.

In FIG. 1H, navigation resumes.

The present invention makes it easy for a passenger navigator to determine what businesses ahead on the route might be interesting. Users can register for business types to be alerted if they are available in the upcoming route.

The present invention has applicability to personal navigation devices, mobile applications, and in-car navigation.

While the invention has been described with reference to the exemplary embodiments thereof, those skilled in the art will be able to make various modifications to the described embodiments of the invention without departing from the true spirit and scope of the invention.

What is claimed is:

1. A method of providing glance ahead points of interest (POI) information along a future segment of a currently calculated route, comprising:
detecting initiation of glance ahead navigation;
receiving user criteria for future POI selection;
selecting a plurality of future POIs meeting said criteria for future POIs, said future POIs being selected during navigation of a calculated route, and said future POIs being proximate a segment of said calculated route significantly beyond a current segment of calculated route;
suspending current navigation;
presenting said plurality of future POIs to a navigation device presenting said calculated route; and
returning to said navigation of said currently calculated route.

2. The method of providing glance ahead points of interest (POI) information about a future segment of a currently calculated route according to claim 1, wherein:
said criteria for future POI is a type of POI.

3. The method of providing glance ahead points of interest (POI) information about a future segment of a currently calculated route according to claim 1, wherein:
said POIs are selected as being proximate about a given street intersection along said currently calculated route.

4. The method of providing glance ahead points of interest (POI) information about a future segment of a currently calculated route according to claim 1, wherein:
said future POIs are proximate to a future freeway exit more than at least 10 miles distant.

5. The method of providing glance ahead points of interest (POI) information about a future segment of a currently calculated route according to claim 1, wherein:
said future POIs are proximate to a future freeway exit more than at least 100 miles distant.

6. The method of providing glance ahead points of interest (POI) information about a future segment of a currently calculated route according to claim 1, wherein:
said future POIs are selected as being within a given travel time to a closest point along any portion of said currently calculated route.

7. The method of providing glance ahead points of interest (POI) information about a future segment of a currently calculated route according to claim 1, further comprising:
providing a user interface permitting a user to customize POI glance ahead searching.

8. The method of providing glance ahead points of interest (POI) information about a future segment of a currently calculated route according to claim 1, wherein:
said customized POI glance ahead includes a user-defined distance radius in which glance ahead future POIs are searched and presented to a user interface of a navigation system.

8. The method of providing glance ahead points of interest (POI) information about a future segment of a currently calculated route according to claim 8, wherein:
said user-defined distance radius is centered about a selected intersection along said calculated route.

9. The method of providing glance ahead points of interest (POI) information about a future segment of a currently calculated route according to claim 2, wherein said type of POI comprises:
businesses.

10. The method of providing glance ahead points of interest (POI) information about a future segment of a currently calculated route according to claim 1, wherein:
said future POIs are provided to said navigation system each displayed with a branded icon.

11. The method of providing glance ahead points of interest (POI) information about a future segment of a currently calculated route according to claim 1, further comprising:
setting a reminder for later presentation when a vehicle including said navigation system moves into a vicinity of said given future POI.

12. The method of providing glance ahead points of interest (POI) information about a future segment of a currently calculated route according to claim 1, wherein:
said glance ahead capability is presented by said user interface as a menu selection.
